(19) United States
(12) Patent Application Publication
(10) Pub. No.: US 2013/0339485 A1
(43) Pub. Date: Dec. 19, 2013

(54) Multi-Threaded Asynchronous Download of a Set of Script files Used in a Web Application

(71) Applicant: Ananya Sen, Fremont, CA (US)

(72) Inventor: Ananya Sen, Fremont, CA (US)

(73) Assignee: MOTOROLA MOBILITY, INC., Libertyville, IL (US)

(21) Appl. No.: 13/495,143

(22) Filed: Jun. 13, 2012

(51) Int. Cl. G06F 15/16

(52) U.S. Cl. 709/219

(57) ABSTRACT

A method for downloading a web application and script files to a computing device from a set of servers includes creating, by a browser thread, a web worker thread, and receiving, in the web worker thread, a request from the browser thread where the request includes identifiers for the script files. The method includes issuing, from the web worker thread, a set of requests for the script files to the set of servers based on the request message, and receiving, in the web worker thread, the script files from the set of servers. The method includes issuing, from the web worker thread, a set of messages to the browser thread, wherein each of the messages includes at least one of the script files, and executing the script files in the browser thread in an order specified by the identifiers.

### BACKGROUND

A web application is accessed by a computing device via a network from a set of servers, and the web application operates on the computing device. A web application typically executes in a web browser, which may retrieve the web application from the set of servers. Web applications include webmail, online media providers, online sales, etc. A web application includes computer code that may be encoded in a browser supported language, such as hyper-text markup language (HTML) where the HTML code may include scripts that rely on external script files. An external script file is a file that is independent from the files of the web application that may use the external script file.

Web applications add functionality to web browsers that are ubiquitously used in computer devices. Moreover, web applications are often used because they are operable in a web browser via download by the web browsers, which alleviates the need for users to load such software onto the users' computers for use. However, if the size of the computer code for a web application and/or the size of a set of external script files (configured for use with the web application) are relatively large, downloading the web application and/or the set of external script files may be relatively slow. It is generally desirable to have the web application and the web application's external script files download and operate relatively quickly.

One solution for improving download speeds of a web application and the web application's external script files is to download the web application and the external script files asynchronously to a computing device. Asynchronous download downloads the external script files when the external script files are needed by the web application, which may be during runtime of the web application. While asynchronous download of a web application and external script files may improve download speed, the execution order of the external script files often lacks control. For example, script DOM (document object model) element injection is one technique that has been used to attempt to define the execution order of the external script files for asynchronous download of a web application and external script files, but execution order of the external script files is not guaranteed by all browsers. For example, during an asynchronous download, a first external script file is supposed to be executed before a second external script file is executed. However, the completion of the downloads of first and second external script files may be out of order where the second external script file may finish downloading before the first external script file finishes downloading. If the execution order is not guaranteed, the second external script file may be executed before the first external script file is executed because the second external script file finished downloading before the first external script file finished downloading. Various solutions exist for preserving execution order of external script files, but these solutions often require prior knowledge about the external script files, which is not always available.

### BRIEF DESCRIPTION OF THE DRAWINGS

FIG. 1 depicts a computing system according to one embodiment for multi-threaded asynchronous download of a web application and a set of external script files.

FIG. 2 depicts a high-level flow diagram of a method for asynchronously downloading a web application and a set of external script files to a browser thread operating in a browser according to one embodiment.

FIG. 3 depicts a software diagram of a browser thread and a web worker thread, and depicts interactions between the browser thread and the web worker thread according to one embodiment.

### DETAILED DESCRIPTION

Described herein are techniques for asynchronous download of a web application and external script files used by the web application. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

According to one embodiment, a method for downloading a web application and a set of external script files operable with the web application to a computing device from a set of servers includes initiating execution of the web application in a browser thread. At runtime of the web application the method includes creating, by the browser thread, a web worker thread, and receiving, in the web worker thread, a request message from the browser thread. The request message includes a list of identifiers for the set of external script files. At the runtime of the web application the method further includes issuing, from the web worker thread, a set of requests for the set of external script files to the set of servers based on the request message, and receiving, in the web worker thread, the set of external script files in a set of responses from the set of servers. At the runtime of the web application the method further includes issuing, from the web worker thread, a set of messages to the browser thread. Each of the messages includes at least one of the external script files. At the runtime of the web application the method includes executing the set of external script files in the browser thread in a sequential order specified by the list of identifiers.

According to another embodiment, a computing device is provided for downloading a web application and a set of external script files operable with the web application from a set of servers. The computing device includes a set of processors; and a computer-readable storage medium that includes instructions for controlling the set of processors to be operable for initiating execution of the web application in a browser thread. At runtime of the web application, instructions are for further controlling the set of processors to be operable for: creating, by the browser thread, a web worker thread; receiving, in the web worker thread, a request message from the browser thread, wherein the request message includes a list of identifiers for the set of external script files; issuing, from the web worker thread, a set of requests for the set of external script files to the set of servers based on the request message; receiving, in the web worker thread, the set of external script files in a set of responses from the set of servers; issuing, from the web worker thread, a set of messages to the browser thread, wherein each of the messages includes at least one of the external script files; and executing the set of external script files in the browser thread in a sequential order specified by the list of identifiers.

According to another embodiment, a non-transitory computer-readable storage medium includes instructions for controlling a computing device for downloading a web application and a set of external script files operable with the web application from a set of servers. The instructions are for controlling the computing device to be operable for initiating execution of the web application in a browser thread. At runtime of the web application the instructions are for further controlling the computing device to be operable for: creating, by the browser thread, a web worker thread; receiving, in the web worker thread, a request message from the browser thread, wherein the request message includes a list of identifiers for the set of external script files; issuing, from the web worker thread, a set of requests for the set of external script files to the set of servers based on the request message; receiving, in the web worker thread, the set of external script files in a set of responses from the set of servers; issuing, from the web worker thread, a set of messages to the browser thread, wherein each of the messages includes at least one of the external script files; and executing the set of external script files in the browser thread in a sequential order specified by the list of identifiers.

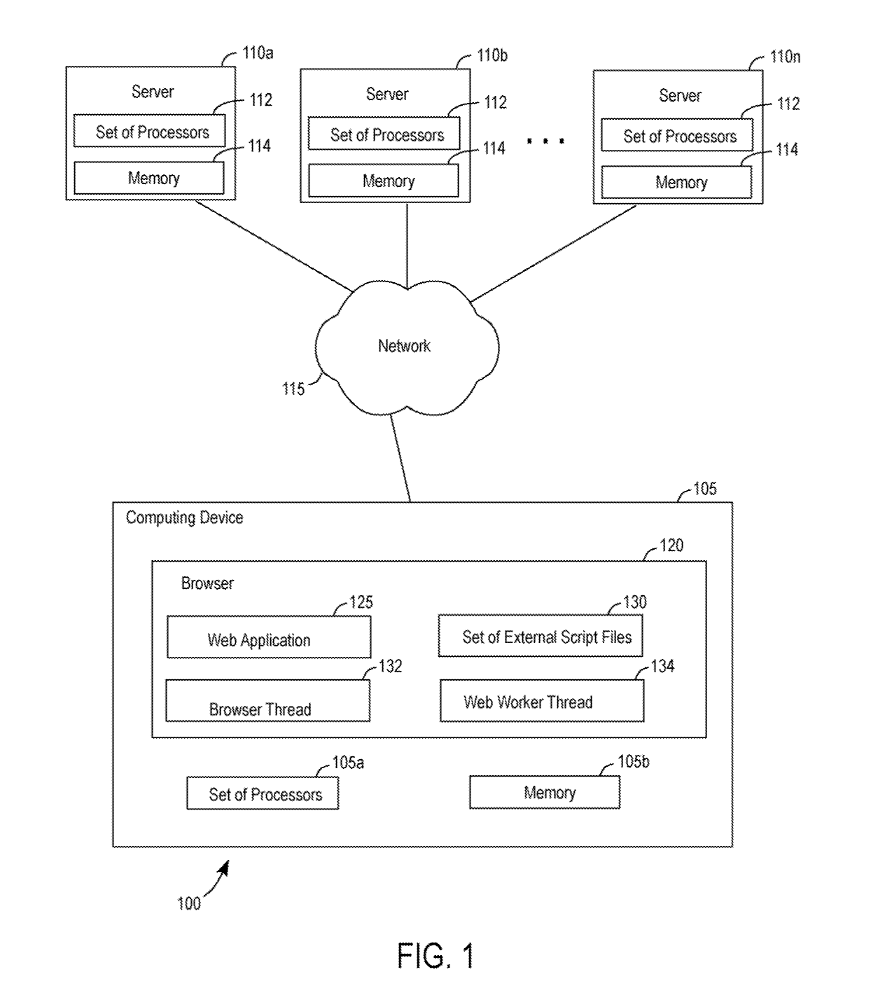

FIG. 1 depicts a computing system 100 for multi-threaded asynchronous download of a web application 125 and a set of external script files 130 according to one embodiment. Computing system 100 includes a computing device 105, a set of servers 110 (labeled 110a, 110b . . . 110n), and a network 115. A set as referred to herein includes one or more elements. Computing device 105 and the set of servers 110 communicate with each other via network 115. Computing device 105 may be one of a variety of devices, such as a mobile device (e.g., a smart phone, a personal digital assistant, etc.), a desktop computer, a laptop computer, a tablet computer, etc. Computing device 105 may include a set of processors 105a and a non-transitory computer readable storage medium (memory) 105b. Memory 105b may store instructions, which the set of processors 105a may execute to carry out various embodiments described herein. Each server 110 may be a computer device that operates a server operating system and includes a set of processors 112 and a non-transitory computer readable storage medium (memory) 114. Each memory 114 may store instructions, which each set of processors 112 may execute to carry out various embodiments described herein. Each server in the set of servers 110 may have a different network domain. Each server may include a single device having a unique network domain or may include a set of devices that share the network domain. Network 115 may include a variety of networks, such as one or more intranets, the Internet, etc.

Computing device 105 operates a browser 120. Browser 120 may execute a web application 125 in a browser environment according to one embodiment. Computing device 105 may download web application 125 from one or more of servers 110 via network 115. Web application 125 may use a set of external script files 130. The set of external script files 130 may be provided by one or more of servers 110 to computing device 105 via network 115. An external script file includes code for scripts that are executed by web application 125 and are external to the files that compose web application 125.

The set of external script files 130 may be provided to computing device 105 during a runtime of web application 125. Runtime includes a time at which web application 125 is executing on computing device 105. For example, runtime may include execution of web application 125 on computing device 105 before all of the code for the web application is downloaded to computing device 105. That is, the execution of web application 125 may begin prior to the entire download of the code for the web application. Downloading the set of external script files 130 during a runtime of web application 125 provides that web application 125 does not share network bandwidth while web application 125 is downloaded from at least one of the servers in the set of servers 110, and/or does not share processing time of computing device 105 with the set of external script files 130 at the start time of the execution of web application 125. Therefore, the execution of web application 125 may be relatively fast.

According to one embodiment, computing device 105 downloads web application 125 from at least one of servers 110 in a browser thread 132, such as an HTML 5 browser thread. HTML 5 includes options for threaded communications over a network. Browser thread 132 may prepare a list of external script files for the set of external script files 130 at a runtime of web application 125. The list of external script files indicates which external script files need to be downloaded during runtime of web application 125.

Browser thread 132 may create a web worker thread 134 that decouples the execution or downloading of external script files 130. For example, browser thread 132 may execute external script files 130 and web worker thread 134 downloads external script files 130. This allows asynchronous dynamic downloading of external script files 130, which can be executed in a desired order.

Browser thread 132 may communicate with the set of servers 110, via the web worker thread 134. For example, browser thread 132 may post (sometimes referred to as “message” or “transmitting”) a request for the set of external script files 130 to web worker thread 134 where the web worker thread 134 requests the set of external script files 130 from set of servers 110. “Message” may be an HTML 5 construct for communicating between threads. Also, web worker threads are a construct of HTML 5. The request posted to web worker thread 134 may include the list of external script files.

Browser thread 132 may prepare a list of external script files. Browser thread 132 uses the list of external script files to track and control an order of execution of the set of external script files 130 required by web application 125. In one embodiment, the list of external script files may be a uniform resource identifier (URI) array with URIs for the set of external script files 130. Browser thread 132 may prepare the list of external script files dynamically while web application 125 is executed in the browser thread. Browser thread 132 may include a “build” class, a “build” function, or the like that dynamically prepares the list of external script files at runtime and inserts the order information for the set of external script files 130 in the list of external script files.

According to one embodiment, web worker thread 134 downloads the set of external script files 130 instead of web worker thread 134. Once the set of external script files 130 are downloaded from the set of servers 110, web worker thread 134 provides the set of external script files 130 asynchronously to browser thread 132. For example, web worker thread 134 may post the set of external script files 130 respectively in a set of messages to browser thread 132. Each external script file may be in a serialized data format in one of the message posted by web worker thread 134 to browser thread 132.

Browser thread 132 uses the execution order in the list of external script files to determine when to execute external scripts 130 that are received from web worker thread 134. For example, browser thread 132 may include a “use” class, a “use” function, or the like, that uses the list of external script files to ensure the execution order of the set of external script files 130 occurs according to the execution order in the list of external script files. More specifically, browser thread 132 (via a use class, a function, or the like) may use the order information in the list of external script files to determine whether a higher-order external script file 130 has executed before a lower-order external script file is executed by the browser thread 132. The higher-order external script file may be required to be executed prior to the lower-order external script file. Different external script files 130 may have different lengths and a lower-order external script file 130 may be relatively small and may be received by browser thread 132 before a higher-order external script file 130 is received by browser thread 132. That is, web worker thread 134 may post the set of external script files 130 respectively in a set of messages to browser thread 132 in a different order than the execution order of the set of external script files 130. Therefore, browser thread 132 may determine whether a higher-order external script file 130 has been received and executed prior to executing a lower-order external script file 130 to provide that the set of external script files 130 are executed according to the execution order.

The use of web worker thread 134 to download the set of external script files 130, compiling the set of external script files 130 in browser thread 132, and the user of the list of external script files, which include the execution order, in browser thread 132, allows browser thread 132 to execute external script files 130 in a different order than an order that external script files 130 may have been downloaded. This is because if browser 120 downloads external script files 130, each external script files 130 is executed when downloading is finished. However, by decoupling the downloading, browser thread 132 can execute external script files 130 in a desired order.

The set of external script files 130 may be compiled in browser thread 132 at runtime of web application 125 and executed in browser thread 132 subsequent to being compiled. The set of external script files 130 may be serialized, as described above, in the messages posted by web worker thread 134 to browser thread 132 and may be parsed and executed via an “eval” function (or similar function or set of functions) in browser thread 132 where the eval function is configured for handing serialized files. Parsing and execution of the set of external script files 130 via web application 125 and/or via browser thread 132 according to the execution order, provides that browser code for browser 120 does not execute the external script files 130 where the browser code for browser 120 may allow the external script files 130 to be executed in an order different from the execution order required by web application 125.

According to one embodiment, the set of external script files 130 is stored in a browser cache of browser 120 for repeated use in an operating session of web application 125. If operation of web application 125 is terminated, such as by closing a tab for a particular browser session, the set of external script files 130 may be re-downloaded from the set of servers 110 for subsequent execution in a subsequent browser session for web application 125.

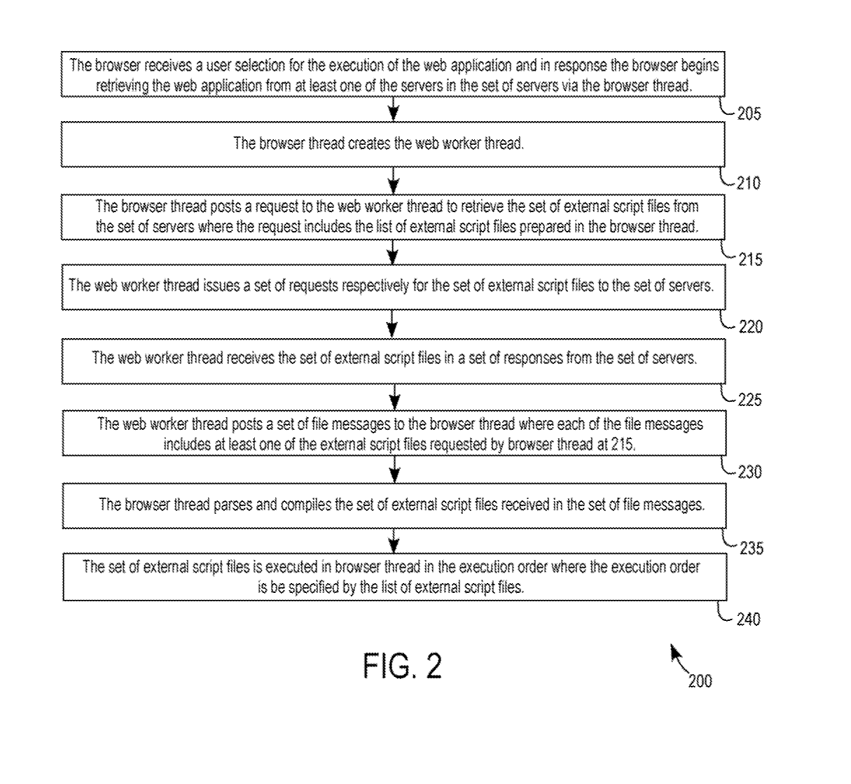

FIG. 2 depicts a high-level flow diagram 200 of a method for asynchronously retrieving web application 125 and the set of external script files 130 from the set of servers 110. High-level flow diagram 200 represents an example embodiment and those of skill in the art will understand that various steps of the high-level flow diagram may be combined and/or added without deviating from the scope and the purview of the embodiment.

At 205, browser 120 receives a user selection for the execution of web application 125. In response to receiving the user selection, browser 120 begins retrieving web application 125 from at least one of the servers in the set of servers 110 via browser thread 132.

In one embodiment, browser 120 performs the following steps during the runtime of web application 125 in browser thread 132.

At 210, browser thread 132 creates web worker thread 134.

At 215, browser thread 132 posts a request (e.g., via a message) to web worker thread 134 to retrieve the set of external script files 130 from the set of servers 110. The request includes the list of external script files prepared in browser thread 132. The set of external script files 130 may be retrieved from the same server that provided web application 125. Alternatively, the set of external script files 130 may be retrieved from one or more different servers from the server that provided web application 125.

At 220, web worker thread 134 issues a set of requests respectively for the set of external script files 130 to the set of servers 110. If the set of external script files 130 is retrieved from one selected server that provides web application 125, web worker thread 134 may issue the request to the selected server may be an XMLHTTPRequest. If the set of external script files 130 is retrieved from one or more different servers from the servers that provides web application 125, web worker thread 134 may issue a number of requests (as compared to a single request) to the one or more different servers for the set of external script files 125. Each request in the number of requests may be a cross-origin resource request for the one or more different servers, and each request in the number of requests may include a cross-origin resource-sharing header. Also, each request in the number of requests may include the list of external script files prepared in browser thread 132.

At 225, web worker thread 134 receives the set of external script files 130 in a set of responses from the set of servers 110. If the responses are generated by one or more servers that are different from the server that provided web application 125, each response may be a cross-origin resource response, and each response may include a cross-origin resource-sharing header.

At 230, web worker thread 134 posts a set of messages to the browser thread 132. Each of the messages includes at least one of the external script files 130 requested by browser thread 132 at 215.

At 235, browser thread 132 parses and compiles the set of external script files 130 received in the set of messages.

At 240, the set of external script files 130 is executed in browser thread 132 in the execution order where the execution order is be specified by the list of external script files.

According to one embodiment a set of cascading style sheet (CSS) files is retrieved and executed via the method described in high-level flow diagram 200. The method of high-level flow diagram 200 may be executed sequentially or serially to retrieve the set of CSS files.

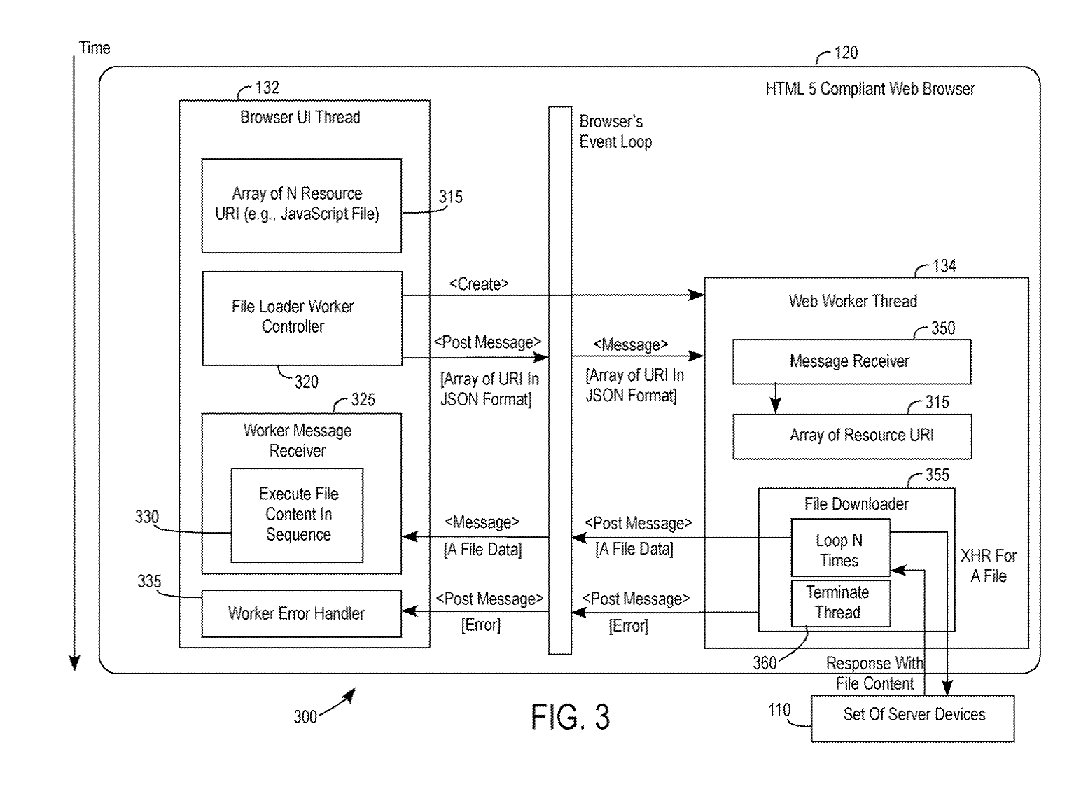

FIG. 3 depicts a software diagram 300 of browser thread 132 and web worker thread 134, and depicts interactions between browser thread 132 and web worker thread 134. As depicted in FIG. 3, browser thread 132 and web worker thread 134 operate in web browser 120, which may be an HTML 5 compliant web browser.

According to one embodiment, browser thread 132 includes the list of external script files (labeled with reference number 315) generated in the browser thread 132 via a build class, a build function, or the like as web application 125 is executed. Browser thread 132 may include a file load worker controller 320 that creates web worker thread 134. File load worker controller 320 may further retrieve the list of external script files 315 and post the set of requests for the set of external script files 130 to web worker thread 134. The list of external script files 315 may be in a JSON (JavaScript Object Notation) format if the set of external script files 130 are JavaScript files.

Browser thread 132 may also include a worker message receiver 325 for receiving the set of messages from web worker thread 134 where the set of messages respectively includes the set of external script files 125. Worker message receiver 325 may include an ordering resource 330 (e.g., a use class, a use function, an eval function, etc.) for parsing, compiling, and executing the set of external script files 125 in the execution order required by web application 125. Browser thread 132 may also include a worker error handler 335 for handling error messages that might be posted to browser thread 132 by web worker thread 134.

According to one embodiment, web worker thread 134 includes a message receiver 350 for receiving requests posted by browser thread 132. Message receiver 350 may extract the list of external script files 315 from the requests received from browser thread 132. Web worker thread 134 may also include a file downloader 355 for retrieving the set of external script files 130 from the set of servers 110. File downloader 355 may issue a set of requests for the set of external script files 130 in a loop manner where the requests are issued sequentially to the set of servers 110. Web worker thread 134 may include a thread termination resource 360 that terminates web worker thread 134 after all of the external script files 130 in the set of script files 130 are posted to browser thread 132. According to one embodiment, browser thread 132 may post a “stop” request to web worker thread 134 so that thread termination resource 360 may terminate web worker thread 134. Browser 120 may post the stop message after the set of external script files 130 are received by worker message receiver 325.

According to one embodiment, browser thread 132 releases memory that stores the messages posted by web worker thread 134 after browser thread 132 executes and/or stores the set of external script files 130 received via the messages. The messages received by browser thread 132 may be relatively large and may consume a relatively large amount of memory, which can be freed after the messages are used.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations, and equivalents may be employed without departing from the scope hereof as defined by the claims.

What is claimed is:

1. A method for downloading a web application and a set of external script files operable with the web application to a computing device from a set of servers, the method comprising:
initiating execution of the web application in a browser thread;
at runtime of the web application, performing:
creating, by the browser thread, a web worker thread;
receiving, in the web worker thread, a request message from the browser thread, wherein the request message includes a list of identifiers for the set of external script files;
issuing, from the web worker thread, a set of requests for the set of external script files to the set of servers based on the request message;
receiving, in the web worker thread, the set of external script files in a set of responses from the set of servers;
issuing, from the web worker thread, a set of messages to the browser thread, wherein each of the messages includes at least one of the external script files; and
executing the set of external script files in the browser thread in an order specified by the list of identifiers.

2. The method of claim 1, further comprising terminating the web worker thread by the browser thread subsequent to the web worker thread issuing the set of messages to the browser thread.

3. The method of claim 2, further comprising issuing a stop message to the web worker thread from the browser thread subsequent to the browser thread receiving the set of messages from the web worker thread.

4. The method of claim 1, wherein the set of servers includes at least one server for providing the web application and the set of external script files.

5. The method of claim 1, wherein the set of servers includes a first server for providing the web application and a second server for providing the set of external script files.

6. The method of claim 5, wherein:
each of the requests in the set of requests includes cross-origin resource-sharing headers for the second server, and
each of the responses in the set of responses includes a cross-origin resource-sharing header for the second server.

7. The method of claim 1, further comprising compiling the set of external script files in the browser thread prior to executing the set of external script files in the order.

8. The method of claim 1, wherein the order specified by the list of identifiers comprises an execution order for the external script files in the set of external script files.

9. The method of claim 1, further comprising determining, by the browser thread, whether a higher-order one of the external script files is executed prior to executing a next lower-order one of the external script files, wherein the higher-order one of the external script files is to be executed prior to the next lower-order one of the external script files as specified by the order in the list of identifiers.

10. The method of claim 9, wherein the higher-order one of the external script files is received by the browser thread after the next lower-order one of the external script files is received by the browser thread.

11. A computing device for downloading a web application and a set of external script files operable with the web application from a set of servers, the computing device comprising:
a set of processors; and
a computer-readable storage medium comprises instructions for controlling the set of processors to be operable for:
initiating execution of the web application in a browser thread;
and at runtime of the web application performing:
creating, by the browser thread, a web worker thread;
receiving, in the web worker thread, a request message from the browser thread, wherein the request message includes a list of identifiers for the set of external script files;
issuing, from the web worker thread, a set of requests for the set of external script files to the set of servers based on the request message;
receiving, in the web worker thread, the set of external script files in a set of responses from the set of servers;
issuing, from the web worker thread, a set of messages to the browser thread, wherein each of the messages includes at least one of the external script files; and
executing the set of external script files in the browser thread in an order specified by the list of identifiers.

12. The computing device of claim 11, wherein the computer-readable storage medium comprises further instructions for controlling the set of processors to be operable for terminating the web worker thread by the browser thread subsequent to the web worker thread issuing the set of messages to the browser thread.

13. The computing device of claim 12, wherein the computer-readable storage medium comprises further instructions for controlling the set of processors to be operable for issuing a stop message to the web worker thread from the browser thread subsequent to the browser thread receiving the set of messages from the web worker thread.

14. The computing device of claim 11, wherein the identifiers in the list of identifiers are uniform resource identifiers, and the list of identifiers includes execution-order information for an execution order of the external script files in the set of external script files.

15. The computing device of claim 11, wherein the computer-readable storage medium comprises further instructions for controlling the set of processors to be operable for determining, by the browser thread, whether a higher-order one of the external script files is executed prior to executing a next lower-order one of the external script files, wherein the higher-order one of the external script files is to be executed prior to the next lower-order one of the external script files as specified by the order the list of identifiers.

16. A non-transitory computer-readable storage medium comprising instructions for controlling a computing device for downloading a web application and a set of external script files operable with the web application from a set of servers, the instructions for controlling the computing device to be operable for:
initiating execution of the web application in a browser thread;
and at runtime of the web application performing:
creating, by the browser thread, a web worker thread;
receiving, in the web worker thread, a request message from the browser thread, wherein the request message includes a list of identifiers for the set of external script files;
issuing, from the web worker thread, a set of requests for the set of external script files to the set of servers based on the request message;
receiving, in the web worker thread, the set of external script files in a set of responses from the set of servers;
issuing, from the web worker thread, a set of messages to the browser thread, wherein each of the messages includes at least one of the external script files; and
executing the set of external script files in the browser thread in an order specified by the list of identifiers.

17. The non-transitory computer-readable storage medium of claim 16, wherein the instructions are for further controlling the computing device for terminating the web worker thread by the browser thread subsequent to the web worker thread issuing the set of messages to the browser thread.

18. The non-transitory computer-readable storage medium of claim 17, wherein the instructions are for further controlling the computing device for issuing a stop message to the web worker thread from the browser thread subsequent to the browser thread receiving the set of messages from the web worker thread.

19. The non-transitory computer-readable storage medium of claim 16, wherein the identifiers in the list of identifiers are uniform resource identifiers, and the list of identifiers includes execution-order information for an execution order of the external script files in the set of external script files.

20. The non-transitory computer-readable storage medium of claim 16, wherein the instructions are for further controlling the computing device for determining, by the browser thread, whether a higher-order one of the external script files is executed prior to executing a next lower-order one of the external script files, wherein the higher-order one of the external script files is to be executed prior to the next lower-order one of the external script files as specified by the order the list of identifiers.
